(19) United States
(12) Patent Application Publication
(10) Pub. No.: US 2015/0140382 A1
(43) Pub. Date: May 21, 2015

(54) ELECTRIC STORAGE DEVICE AND ELECTRIC STORAGE DEVICE MODULE

(71) Applicant: GS Yuasa International Ltd., Kyoto-shi (JP)

(72) Inventors: Tomonori KAKO, Kyoto-shi (JP); Takeshi Sasaki, Kyoto-shi (JP)

(21) Appl. No.: 14/532,110

(22) Filed: Nov. 4, 2014

(30) Foreign Application Priority Data
Nov. 15, 2013 (JP) 2013-237221
Sep. 19, 2014 (JP) 2014-191185

(51) Int. Cl. H01M 10/04; H01M 2/20

(52) U.S. Cl. CPC H01M 10/0431; H01M 2/204; H01M 2/206
USPC 429/94

(57) ABSTRACT

An electric storage device includes an electrode assembly including a winding core and electrodes, and a case. The case and the winding core each have a rigidity satisfying 0.01≦P₂/P₁≦100, where P₂/P₁ is a ratio of a first pressure P₁ applied to a first part as a specific part of the case by an indenter when the first part is pressed by the indenter so as to be displaced 1 mm from the initial position in a state where the electrode assembly is not housed in the case, and a second pressure P₂ applied to a second part as a part of the winding core facing the first part by the indenter when the second part is pressed by the indenter so as to be displaced 1 mm from the initial position in a state where the electrodes are not wound.

### CROSS-REFERENCE TO RELATED APPLICATIONS

This application claims the benefit of Japanese Patent Application Nos. 2013-237221 and 2014-191185, filed on Nov. 15, 2013 and Sep. 19, 2014, respectively, which are incorporated herein by reference.

### FIELD

The present invention relates to an electric storage device capable of being charged and discharged, and an electric storage device module including the electric storage device.

### BACKGROUND

Conventionally, an electric storage device capable of being charged and discharged, which includes an electrode assembly and a case to house the electrode assembly, such as a secondary battery cell, is known. Examples of the electric storage device of this type include an electric storage device which includes an electrode assembly 100 including a winding core 101 and electrodes 102 wound around the circumference of the winding core 101, as shown in FIG. 12 (also see JP H6-203870 A). In such an electric storage device, expansion and contraction of the electrodes 102 are repeated as the charge-discharge cycle is repeated. Therefore, the electric storage device may possibly undergo deterioration of properties in relation to the charge and discharge, such as a capacity retention rate, due to deformation or the like of the electrodes 102 caused by the expansion and contraction.

### SUMMARY

The following presents a simplified summary of the invention disclosed herein in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

It is an object of the present invention to provide an electric storage device and an electric storage device module capable of suppressing the deterioration of properties in relation to charge and discharge during repetition of the charge-discharge cycle.

According to an aspect of the present invention, an electric storage device includes: an electrode assembly including a winding core and electrodes wound around a circumference of the winding core; and a case including a circumferential wall, the case housing the electrode assembly therein in a state where the electrodes are closely stacked between the circumferential wall and the winding core, wherein the case and the winding core each have a rigidity satisfying 0.01≦P₂/P₁≦100, where P₂/P₁ is a ratio of a first pressure P₁ applied to a first part as a specific part of the case by an indenter when the first part is pressed by the indenter so as to be displaced 1 mm from the initial position in a state where the electrode assembly is not housed in the case, and a second pressure P₂ applied to a second part as a part of the winding core facing the first part by the indenter when the second part is pressed by the indenter so as to be displaced 1 mm from the initial position in a state where the electrodes are not wound.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The foregoing and other features of the present invention will become apparent from the following description and drawings of an illustrative embodiment of the invention in which:

FIG. 1 is a perspective view of a non-aqueous electrolyte secondary battery cell according to this embodiment;

FIG. 2 is a sectional view at the position in FIG. 1;

FIG. 3 is an enlarged sectional view at the position in FIG. 1;

FIG. 4 is a view explaining how to determine a first pressure;

FIG. 5 is a view explaining how to determine a second pressure;

FIG. 6 is a schematic perspective view of an electric storage device module;

FIG. 7 is a perspective view showing a one-fourth model of a symmetry constrained case;

FIG. 8 is an analysis view showing displacement in each part of the case when the model of the case is pressed by a one-fourth model of a circular indenter;

FIG. 9 is a perspective view showing a one-fourth model of a symmetry constrained winding core;

FIG. 10 is an analysis view showing displacement in each part of the winding core when the model of the winding core is pressed by the one-fourth model of the circular indenter;

FIG. 11 is a graph showing the results of a charge cycle test; and

FIG. 12 is a perspective view of an electrode assembly of a conventional secondary battery cell.

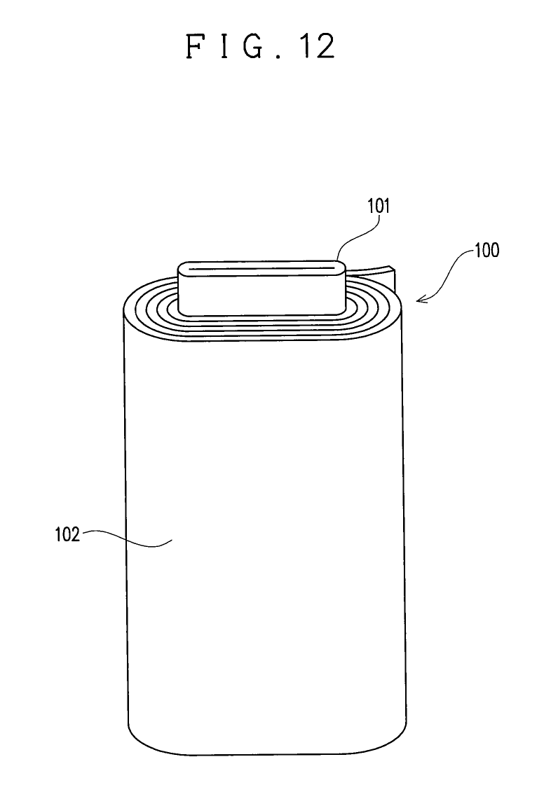

### DESCRIPTION OF EMBODIMENTS

As a result of diligent studies to overcome the aforementioned problem, the inventors of the present embodiment have found that the degree of deformation, or the like, caused by repetition of a charge-discharge cycle (that is, repetition of expansion and contraction of wound electrodes) in an electric storage device changes depending on the balance between the force with which a case presses the electrodes and the force with which a winding core presses the electrodes when the electrodes expand and contract. Based on this finding, the inventors have devised an electric storage device and an electric storage device module with the following configurations, focusing on the balance between the force with which the case presses the electrodes and the force with which the winding core presses the electrodes.

The electric storage device according to this embodiment includes: an electrode assembly including a winding core and electrodes wound around a circumference of the winding core; and a case including a circumferential wall, the case housing the electrode assembly therein in a state where the electrodes are closely stacked between the circumferential wall and the winding core, wherein the case and the winding core each have a rigidity satisfying 0.01≦P₂/P₁≦100, where P2/P1 is a ratio of a first pressure P1 applied to a first part as a specific part of the case by an indenter when the first part is pressed by the indenter so as to be displaced 1 mm from the initial position in a state where the electrode assembly is not housed in the case, and a second pressure P2 applied to a second part as a part of the winding core facing the first part by the indenter when the second part is pressed by the indenter so as to be displaced 1 mm from the initial position in a state where the electrodes are not wound.

According to such a configuration, the electrodes are sandwiched by the case and the winding core from the inside and outside with an appropriate force in a balanced manner, when the electrodes expand and contract due to the charge-discharge cycle. Therefore, distortion, deformation, or the like, of the wound electrodes caused by the expansion and contraction due to charge and discharge is suppressed, thereby allowing deterioration of properties in relation to charge and discharge (such as a capacity retention rate) during repetition of the charge-discharge cycle to be suppressed.

In this case, it is preferable that the first pressure P₁ and the second pressure P₂ be each at least 1 kgf/cm².

If the first pressure P₁ and the second pressure P₂ are each lower than 1 kgf/cm², the case and the winding core that have been deformed due to the expansion and contraction of the electrodes are less likely to return to the original shapes, and thus gaps tend to occur between the wound electrodes. However, according to the aforementioned configuration, the case and the winding core deformed as described above can be prevented from being less likely to return to the original shapes.

Further, the first pressure P₁ and the second pressure P₂ each may be not more than 100 kgf/cm².

If the first pressure P₁ and the second pressure P₂ are each higher than 100 kgf/cm², the case and the winding core cannot be sufficiently deformed when the electrodes expand, which may result in damage, or the like, of the electrodes due to a high pressure being applied to the electrodes themselves. However, according to the aforementioned configuration, the damage, or the like, can be prevented by sufficient deformation of the case and the winding core during the expansion of the electrodes.

Further, it is preferable that the ratio P₂/P₁ of the first pressure P₁ and the second pressure P₂ satisfy 0.1≦P₂/P₁≦10.

According to such a configuration, when the electrodes expand and contract due to the charge-discharge cycle, the electrodes are sandwiched by the case and the winding core from the inside and outside with an appropriate force in a balanced manner. This can more effectively suppress the deterioration of properties in relation to charge and discharge (such as a capacity retention rate) during repetition of the charge-discharge cycle.

Further, it is more preferable that the ratio P₂/P₁ of the first pressure P₁ and the second pressure P₂ be 1.

According to such a configuration, the deterioration of properties in relation to charge and discharge (such as a capacity retention rate) during repetition of the charge-discharge cycle can be most suppressed.

The electric storage device may have a configuration in which the case includes: a rectangular bottom wall; a pair of long walls erected from positions along long sides of circumferential edges of the bottom wall; and a pair of short walls erected from positions along short sides of circumferential edges of the bottom wall, the pair of short walls connecting ends of the pair of long walls that face each other.

In this case, the configuration may be such that the winding core includes flat parts, the case houses the electrode assembly to have the flat parts of the winding core and the long walls being substantially in parallel, and the electrodes are sandwiched between the long walls of the case and the flat parts of the winding core.

The electric storage device module according to an aspect of this embodiment includes: the aforementioned electric storage device; and a bus bar member electrically connected to the electric storage device.

According to such a configuration, in the electric storage device constituting the electric storage device module, the electrodes are sandwiched by the case and the winding core from the inside and outside with an appropriate force in a balanced manner, when the electrodes expand and contract due to the charge-discharge cycle. Therefore, distortion, deformation, or the like, of the wound electrodes caused by the expansion and contraction due to charge and discharge is suppressed, thereby allowing deterioration of properties in relation to charge and discharge (such as a capacity retention rate) during repetition of the charge-discharge cycle to be suppressed, in the electric storage device constituting the electric storage device module. As a result, deterioration of properties in relation to charge and discharge is suppressed also in the electric storage device module.

As can be seen from the above, the present embodiment can provide an electric storage device and an electric storage device module which are capable of suppressing the deterioration of properties in relation to charge and discharge during repetition of the charge-discharge cycle.

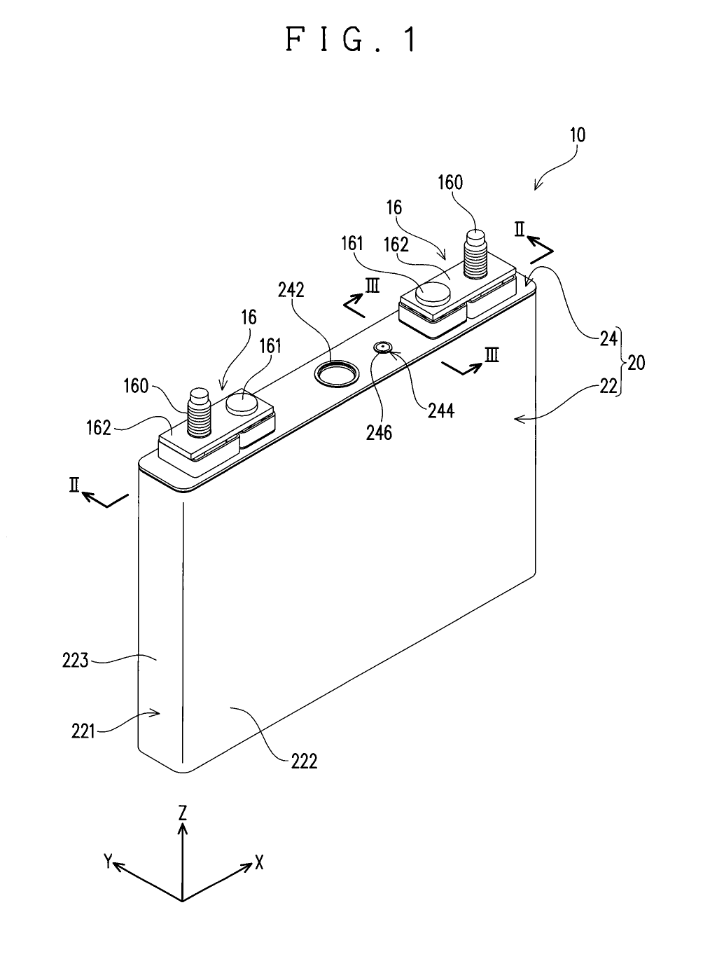

Hereinafter, an embodiment of the present invention is described with reference to FIG. 1 to FIG. 5. The electric storage device according to this embodiment is a non-aqueous electrolyte secondary battery cell (which hereinafter is referred to simply as “battery cell”) such as a lithium ion secondary battery cell.

Specifically, a battery cell 10 includes a case 20, an electrode assembly 12, a pair of current collectors 14, and a pair of terminal parts 16, as shown in FIG. 1 to FIG. 3.

The case 20 has a case body 22 and a cover plate 24. The case 20 houses the electrode assembly 12, the pair of current collectors 14, an electrolyte, etc., within an internal space S surrounded by the case body 22 and the cover plate 24. The case body 22 and the cover plate 24, for example, are made of aluminum or an aluminum-based metal material such as aluminum alloy. The ends of the case body 22 and the cover plate 24 are welded together, thereby forming the case 20.

It should be noted that the materials of the case body 22 and the cover plate 24 are not limited to aluminum-based metals. The case body 22 and the cover plate 24 may be made of metal materials such as SUS and nickel, or composite materials obtained by bonding a resin such as nylon to aluminum, for example.

The case body 22 has a flattened bottomed rectangular cylindrical shape. Specifically, the case body 22 has a bottom wall 220, and circumferential walls 221 erected in the normal direction of the bottom wall 220 from the circumferential edges of the bottom well 220 into a rectangular cylindrical shape. The bottom wall 220 has a rectangular shape elongated in one direction and having four arcuate corners, as seen in the normal direction of the bottom wall 220. The circumferential walls 221 include a pair of long walls 222 erected from the positions along the long sides of the circumferential edges of the bottom wall 220, and a pair of short walls 223 erected from the positions along the short sides of the circumferential edges of the bottom wall 220. In the following description, the long side direction of the bottom wall 220 is referred to as the X-axis direction, the short side direction of the bottom wall 220 is referred to as the Y-axis direction, and the normal direction of the bottom wall 220 is referred to as the Z-axis direction (see FIG. 1).

The case body 22 is formed to have the balance of strength (rigidity) between the case 20 and a winding core 120 of the electrode assembly 12 falling within a specific range. The balance of strength will be described in detail below.

The cover plate 24 is placed over the circumferential edges of an opening of the case body 22 so as to seal the opening of the case body 22. The cover plate 24 has a shape corresponding to the outer circumferential edges (contour) of the case body 22 in plan view. That is, the cover plate 24 is a rectangular plate member elongated in the X-axis direction and having four arcuate corners in plan view.

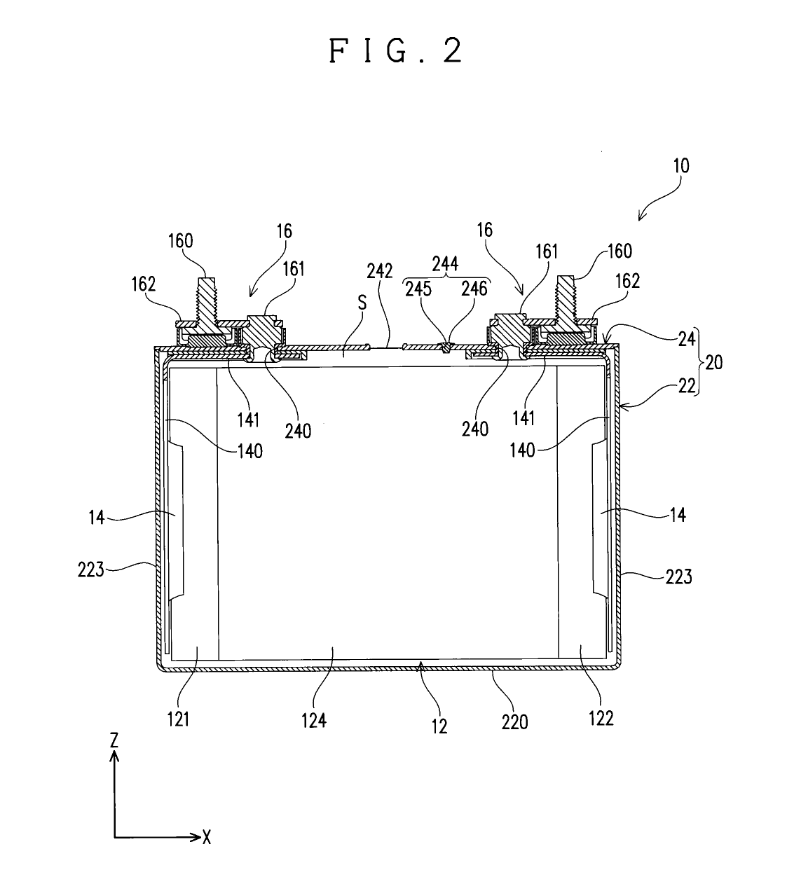

Further, the cover plate 24 is provided with a pair of terminal through holes 240, a gas discharge valve 242, and an injection part 244 (see FIG. 2). The pair of terminal through holes 240 are provided at an interval in the X-axis direction in the cover plate 24. The gas discharge valve 242 has a thin part and a breakable groove, and is provided at the center of the cover plate 24. The gas discharge valve 242 discharges a gas inside the case 20 when the internal pressure (gas pressure) of the case 20 exceeds a specific value, by allowing the breakable groove to split and thereby allowing communication between the inside and the outside of the case 20. Thus, the gas discharge valve 242 reduces the increased internal pressure of the case 20. The injection part 244 has a liquid injection hole 245 provided in the cover plate 24, and a stopper 246 sealing the liquid injection hole 245. The liquid injection hole 245 is an opening through which an electrolyte liquid is injected into the case 20, and the stopper 246 closes the liquid injection hole 245 by being inserted into the liquid injection hole 245 after the liquid injection.

The dimensions of the case 20 including the case body 22 and the cover plate 24, for example, are as follows.

It is preferable that the width of the case body 22 (dimension in the X-axis direction in FIG. 1) be 80 to 200 mm, the depth of the case body 22 (dimension in the Y-axis direction in FIG. 1) be 6 to 30 mm, and the height of the case body 22 (dimension in the Z-axis direction in FIG. 1) be 60 to 150 mm. It is more preferable that the width of the case body 22 (dimension in the X-axis direction in FIG. 1) be 100 to 150 mm, the depth of the case body 22 (dimension in the Y-axis direction in FIG. 1) be 8 to 15 mm, and the height of the case body 22 (dimension in the Z-axis direction in FIG. 1) be 70 to 100 mm.

The thickness of each of the circumferential walls 221 and the bottom wall 220 of the case body 22 is preferably 0.2 to 1.2 mm, more preferably 0.3 to 0.7 mm. In the case where a hollow winding core with a thickness of 0.5 mm or less is used as the winding core 120, the thickness of each of the circumferential walls 221 and the bottom wall 220 of the case body 22 is preferably 0.2 to 0.5 mm. The thickness of the cover plate 24 is preferably 0.2 to 1.5 mm, more preferably 0.5 to 1.2 mm.

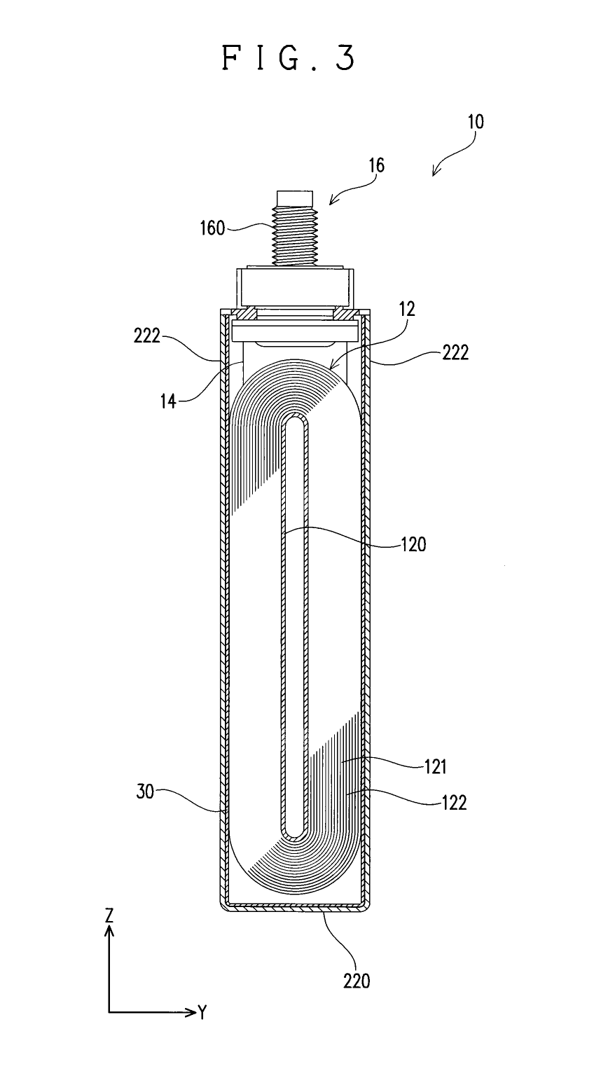

The electrode assembly 12 has the winding core 120 and electrodes 121 and 122 wound around the circumference of the winding core 120 (see FIG. 2 and FIG. 3).

The winding core 120 has a hollow elongated cylindrical shape such that its cross sections (specifically, contours of the cross sections) along the Y-axis direction and the Z-axis direction each have the same oblong shape at positions in the X-axis direction. The winding core 120, for example, is formed by winding a film or a plate that is made of a synthetic resin such as polypropylene, polyethylene, and polyphenylene sulfide, and bonding or welding it.

It should be noted that the material of the winding core 120 is not limited to the synthetic resin, and may be, for example, a metal such as aluminum and copper. Further, the winding core 120 does not necessarily have a hollow structure, and may have a solid structure. In this case, the winding core 120 is made of a soft material having a resistance to the electrolyte such as rubber.

The winding core 120 is formed to have the balance of strength (rigidity) between the winding core 120 and the case 20 falling within a specific range. In this embodiment, the case 20 and the winding core 120 are formed, using a pressure ratio of P₁ and P₂ (P₂/P₁) determined by the following method as a measure of the balance of strength (rigidity), to have this ratio falling within a specific range.

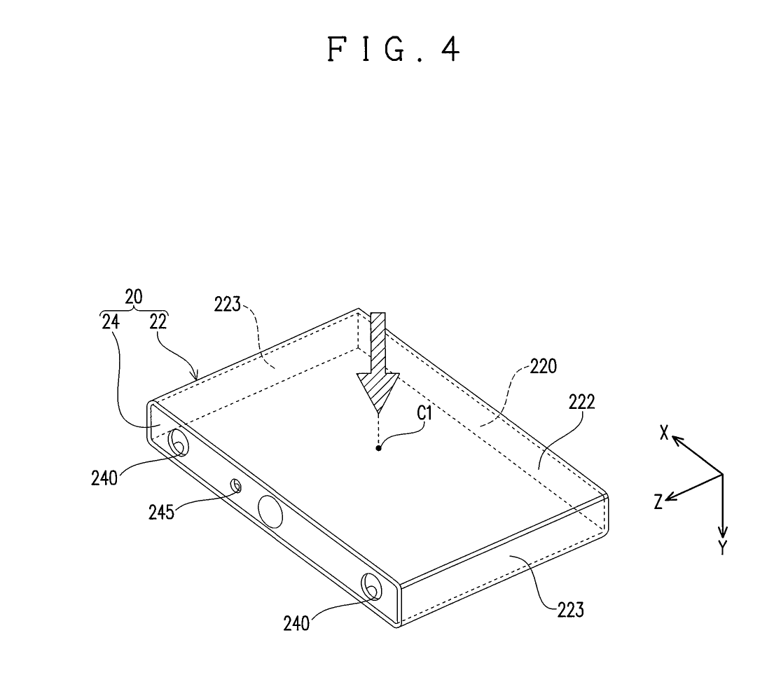

As shown in FIG. 4, the center (first part) C1 of one of the long walls 222 of the case 20 in which the electrode assembly 12 is not housed (that is, the case 20 the internal space of which is empty) is pressed in the Y-axis direction (in the normal direction of the long wall 222) by a circular indenter with a diameter of 10 mm (see the arrow in FIG. 4). The area of an abutting surface (pressure surface) of the indenter used herein against the object to be pressed is 0.785 cm². The pressure applied to the center C1 by the indenter when the center C1 is displaced 1 mm from the initial position (the position of the center C1 when no pressure is applied thereto by the indenter) by being pressed by the indenter is referred to as a first pressure P₁.

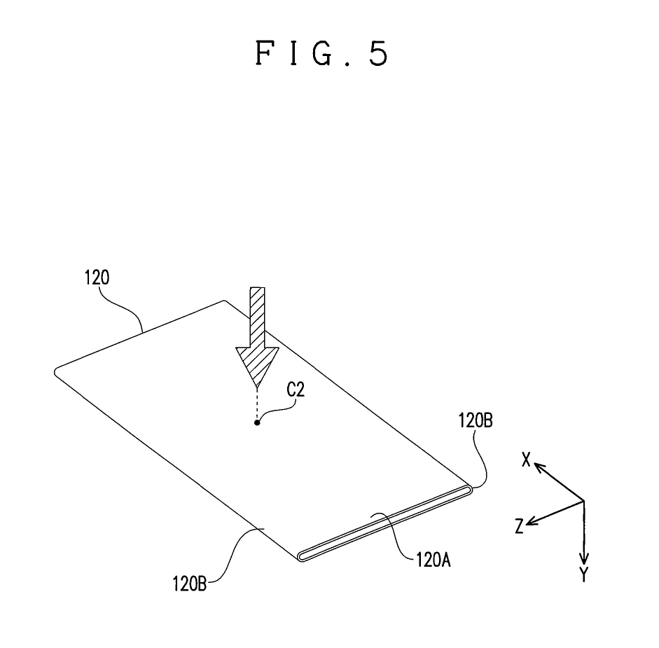

Further, as shown in FIG. 5, the center (second part) C2 of one of flat parts 120A (the parts other than the parts 120B located at both ends in the Z-axis direction, where the electrodes 121 and 122 are stacked in a bent state) of the winding core 120 around which the electrodes 121 and 122 are not wound is pressed in the Y-axis direction (in the normal direction of the flat part 120A of the winding core 120) by the indenter (see the arrow in FIG. 5). The pressure applied to the center C2 by the indenter when the center C2 is displaced 1 mm from the initial position (the position of the center C2 when no pressure is applied thereto by the indenter) by being pressed by the indenter is referred to as a second pressure P₂. It should be noted that the center C2 of the winding core 120 is a part (position) facing the center C1 of the long wall 222 of the case 20 when the winding core 120 is housed in the case 20.

In this embodiment, the case 20 and the winding core 120 each have a rigidity such that a ratio P₂/P₁ of the first pressure P₁ and the second pressure P₂ thus obtained is 1. For example, the case 20 and the winding core 120 are each formed so as to satisfy the aforementioned condition (P₂/P₁=1) by adjusting the dimensions of each part, their materials, or the like. In this way, when the wound electrodes 121 and 122 expand and contract due to the charge-discharge cycle, the wound electrodes 121 and 122 are sandwiched by the case 20 (the long walls 222) and the winding core 120 (the flat parts 120A) from the inside and outside with an appropriate force in a balanced manner. Thus, deformation, or the like, of the wound electrodes 121 and 122 caused by repetition of the expansion and contraction, and separation of mixture layers of the electrodes 121 and 122, for example, are effectively suppressed.

Further, the case 20 and the winding core 120 of this embodiment have a rigidity such that the first pressure P₁ and the second pressure P₂ are each at least 1 kgf/cm². This is because, if the case 20 and the winding core 120 have a rigidity such that the first pressure P₁ and the second pressure P₂ are each lower than 1 kgf/cm², the case 20 and the winding core 120 that have been deformed due to the expansion and contraction of the electrodes 121 and 122 are less likely to return to the original shapes, as a result of which gaps tend to occur between the wound electrodes 121 and 122. That is, when the case 20 and the winding core 120 have a rigidity such that the first pressure P₁ and the second pressure P₂ are each at least 1 kgf/cm², the case 20 and the winding core 120 that have been deformed due to the expansion and contraction of the electrodes 121 and 122 can be prevented from being less likely to return to the original shapes.

Further, the case 20 and the winding core 120 of this embodiment have a rigidity such that the first pressure P₁ and the second pressure P₂ are each not more than 100 kgf/cm². This is because, if the case 20 and the winding core 120 have a rigidity such that the first pressure P₁ and the second pressure P₂ are each higher than 100 kgf/cm², the case 20 and the winding core 120 cannot be sufficiently deformed when the electrodes 121 and 122 expand, which may possibly result in a damage (such as cracks occurring in the electrode foils or the active material layers) of the electrodes 121 and 122 due to a high pressure being applied to the electrodes 121 and 122 themselves when the electrodes 121 and 122 expand. That is, when the case 20 and the winding core 120 have a rigidity such that the first pressure P₁ and the second pressure P₂ are each not more than 100 kgf/cm², the case 20 and the winding core 120 are deformed when the electrodes 121 and 122 expand, thereby allowing such a damage to be prevented.

The dimension of the winding core 120 in the Y-axis direction is preferably more than 1 mm. The reasons for this are as follows. If the dimension of the winding core 120 in the Y-axis direction is 1 mm or less, the flat parts 120A cannot be recessed during the expansion and contraction of the electrodes 121 and 122 to an extent that allows the expansion and contraction, as a result of which the electrodes 121 and 122 cannot be sandwiched by the case 20 (the long walls 222) and the winding core 120 (the flat parts 120A) from the inside and outside with an appropriate force in a balanced manner, when the wound electrodes 121 and 122 expand and contract due to the charge-discharge cycle. Therefore, the deformation, or the like, caused by repetition of the expansion and contraction of the electrodes 121 and 122 cannot be suppressed, and thus the deterioration of properties in relation to charge and discharge cannot be suppressed. Here, the dimension of the winding core 120 in the Y-axis direction is the thickness dimension in the Y-axis direction in the case of a solid structure, and it is the distance between the outer surfaces of the flat parts 120A in the Y-axis direction in the case of a hollow structure.

Further, in the case of a battery cell provided with an electrode assembly including no winding core (battery cell in which no winding core is arranged inside wound electrodes), there is no (or exceptionally small) escape space of the electrodes to the inside of the wound electrodes (winding center side) when the electrodes expand. Therefore, also in the case of the electrode assembly including no winding core, the wound electrodes 121 and 122 cannot be sandwiched from the inside and outside with an appropriate force in a balanced manner. Therefore, deformation, or the like, of the wound electrodes 121 and 122 caused by repetition of the expansion and contraction of the electrodes 121 and 122 cannot be suppressed.

The first pressure P₁ applied to the case 20 of this embodiment and the second pressure P₂ applied to the winding core 120 are each measured (calculated) by analysis using computer simulation. Specifically, the measurement is as follows.

In the measurement of the first pressure P₁ applied to the case 20, a model to which the material, shape, and dimensions of the case 20 are input is first prepared. Next, the center (first part) C1 of the long wall 222 in the model of the case 20 is pressed in the. Y-axis direction (in the normal direction of the long wall 222) by a circular indenter with a diameter of 10 mm (see the arrow in FIG. 4). The area of an abutting surface (pressure surface) of the circular indenter used herein against the object to be pressed (in the example of this embodiment, the long wall 222 of the case 20) is 0.785 cm². Then, the pressure applied to the center C1 by the circular indenter when the center C1 is displaced 1 mm from the initial position (position of the center C1 when no pressure is applied thereto by the circular indenter) by being pressed by the circular indenter is analyzed (calculated) using computer simulation. Thus, the first pressure P₁ is obtained (measured). In the case of the case 20 having a symmetrical shape, analysis may be performed using a symmetry constrained model (analysis technique in which only a part on one side with respect to the symmetrical surface is analyzed) in the measurement of the first pressure P₁.

In the measurement of the second pressure P₂ applied to the winding core 120, a model in which the material, shape, and dimensions of the winding core 120 are input is first prepared. Next, the center (second part) C2 of the flat part 120A in the model of the winding core 120 is pressed in the Y-axis direction (in the normal direction of the flat part 120A of the winding core 120) by the circular indenter (see the arrow in FIG. 5). Then, the pressure applied to the center C2 by the circular indenter when the center C2 is displaced 1 mm from the initial position (position of the center C2 when no pressure is applied thereto by the circular indenter) by being pressed by the circular indenter is analyzed (calculated) using computer simulation. Thus, the second pressure P₂ is obtained (measured). In the case of the winding core 120 having a symmetrical shape, analysis may be performed using a symmetry constrained model (analysis technique in which only a part on one side with respect to the symmetrical surface is analyzed) in the measurement of the second pressure P₂.

The electrode assembly 12 of this embodiment has a strip-shaped positive electrode (electrode on the positive side) 121, a strip-shaped negative electrode (electrode on the negative side) 122, and a strip-shaped separator 124, which are wound around the circumference of the winding core 120. The positive electrode 121 and the negative electrode 122 shifted from each other in the width direction (in a direction orthogonal to the longitudinal direction of the strip-shaped electrodes 121 and 122: the X-axis direction in FIG. 2) are wound into an elongated cylindrical shape around the circumference of the winding core 120, with the separator 124 interposed therebetween (see FIG. 3). The electrodes 121 and 122 thus wound into the elongated cylindrical shape have an oblong cross section (the contour of the cross section) along the Y axis and Z axis.

The positive electrode 121, for example, is a strip-shaped aluminum foil on the surface of which a positive electrode active material is supported. The negative electrode 122, for example, is a strip-shaped copper foil on the surface of which a negative electrode active material is supported. The positive electrode 121 and the negative electrode 122 have portions to which no active materials are applied along their end edges in the width direction (X-axis direction). Thus, the aluminum foil and the copper foil to which no active materials are applied are exposed at the ends in the width direction of the electrode assembly 12 (X-axis direction). In this way, the electrode assembly 12 includes a projection on the positive electrode side (positive electrode of the electrode assembly) 126 formed by only the positive electrode 121 (portion to which the positive electrode active material is not applied) projecting at one end in the width direction (X-axis direction), and a projection on the negative electrode side (negative electrode of the electrode assembly) 126 formed by only the negative electrode 122 (portion to which the negative electrode active material is not applied) projecting at the other end in the width direction (X-axis direction).

The positive electrode active material preferably contains a composite oxide represented by LiₐMe_{b}O_{c} (where Me denotes one, or two or more transition metals) (such as LiₐCo_{y}O₂, LiₐNiₓO₂, LiₐMn_{z}O₄, and LiₐNiₓCo_{y}Mn_{z}O₂). Further, it is preferable that Me at least contain all of Ni, Co, and Mn.

The negative electrode active material preferably contains a carbonate material such as graphite, non-graphitizable carbon, and graphitizable carbon, or a material that undergoes an alloying reaction with lithium ions such as silicon (Si) and tin (Sn). The negative electrode active material more preferably contains at least one of graphite, non-graphitizable carbon, and graphitizable carbon.

The thus configured electrode assembly 12 housed in an insulating member 30 is housed within the case 20 in a position such that the winding axis direction coincides with the longitudinal direction of the case 20 (X-axis direction), and the major axis direction coincides with the normal direction of the bottom wall 220 (Z-axis direction) (see FIG. 3). In the battery cell 10 of this embodiment, the electrodes 121 and 122 are pressed against the winding core 120 by the pair of long walls 222 of the case 20 facing each other, thereby allowing the electrodes 121 and 122 to be housed (arranged) within the case 20 so that the electrodes 121 and 122 that are adjacent (stacked) in the Y-axis direction are in tight contact with each other. That is, the electrode assembly 12 is housed within the case 20 with the electrodes 121 and 122 being closely stacked between the long walls 222 and the flat parts 120A of the winding core 120.

The current collectors 14 are arranged along the electrode assembly 12 within the case 20 so as to conduct the projections 126 of the electrode assembly 12 to the terminal parts 16. The battery cell 10 of this embodiment includes a positive electrode current collector 14 and a negative electrode current collector 14. The positive electrode current collector 14 conducts the projection 126 on the positive electrode side to the positive electrode terminal part 16. The negative electrode current collector 14 conducts the projection 126 on the negative electrode side to the negative electrode terminal part 16. In this embodiment, the positive electrode current collector 14, for example, is made of aluminum or aluminum alloy. Further, the negative electrode current collector 14, for example, is made of copper or copper alloy.

Each of the current collectors 14 has a terminal-side connection part 140 that is directly or indirectly connected to one of the terminal parts 16, and an electrode assembly-side connection part 141 that is directly or indirectly connected to one of the projections 126 of the electrode assembly 12. The current collector 14 is formed into a bent shape (substantially L-shape) at the boundary between the terminal-side connection part 140 and the electrode assembly-side connection part 141 so as to extend along the electrode assembly 12 in front view, by bending a plate metal material that has been cut into a specific shape.

The terminal part 16 is attached to the cover plate 24 so as to pass through one of the terminal through holes 240 of the cover plate 24. Specifically, the terminal part 16 has an external terminal 160, a rivet 161, and a conductive part 162. The external terminal 160 extends upward outside the case 20. The rivet 161 passes through the terminal through hole 240 of the cover plate 24 so as to fix the current collector 14 (the terminal-side connection part 140) and the conductive part 162 to the cover plate 24 in a conductive manner. The conductive part 162 connects the external terminal 160 to the current collector 14 via the rivet 161 in a conductive manner.

In the battery cell 10 configured as above, when the electrodes 121 and 122 expand and contract due to the charge-discharge cycle, the wound electrodes 121 and 122 are sandwiched by the case 20 (the long walls 222) and the winding core 120 (the flat parts 120A) from the inside and outside with an appropriate force in a balanced manner. Therefore, distortion, deformation, or the like, of the wound electrodes 121 and 122 caused by the expansion and contraction due to charge and discharge can be efficiently suppressed. As a result, the deterioration of properties in relation to charge and discharge (such as a capacity retention rate) during repetition of the charge-discharge cycle can be suppressed in the battery cell 10.

It is a matter of course that the electric storage device of the present invention is not limited to the above described embodiment, and various modifications can be made without departing from the gist of the present invention.

In the battery cell 10 of the aforementioned embodiment, the ratio P₂/P₁ of the first pressure P₁ and the second pressure P₂ is 1. However, there is no limitation to this configuration. When the ratio P₂/P₁ of the first pressure P₁ and the second pressure P₂ is 1, the deterioration of properties in relation to charge and discharge (such as a capacity retention rate) during repetition of the charge-discharge cycle is most suppressed. However, the case 20 and the winding core 120 only needs to be formed to have the ratio P₂/P₁ of the first pressure P₁ and the second pressure P₂ satisfying 0.01≦P₂/P₁≦100, more preferably 0.1≦P₂/P₁≦10. That is, it suffices that the case 20 and the winding core 120 have a rigidity such that the ratio P₂/P₁ of the first pressure P₁ and the second pressure P₂ satisfies 0.01≦P₂/P₁≦100 (more preferably, 0.1≦P₂/P₁≦10). According to such a configuration, when the electrodes 121 and 122 expand and contract due to the charge-discharge cycle, distortion, deformation, or the like, of the wound the electrodes 121 and 122 caused by the expansion and contraction due to the charge and discharge is suppressed. This allows the deterioration of properties in relation to charge and discharge during repetition of the charge-discharge cycle to be sufficiently suppressed.

Further, in the battery cell 10 of the aforementioned embodiment, the number of the electrode assembly 12 housed in the case 20 is one. However, two or more electrode assemblies may be housed therein.

Further, in the aforementioned embodiment, a rechargeable secondary battery cell (lithium ion secondary battery cell) has been described. However, the type and size (capacity) of the battery cell is arbitrarily selected. Further, a lithium ion secondary battery cell has been described in the aforementioned embodiment as an example of the electric storage device. However, there is no limitation to this. For example, the present invention can be applied also to electric storage devices of primary battery cells and capacitors such as an electric double layer capacitor in addition to various secondary battery cells.

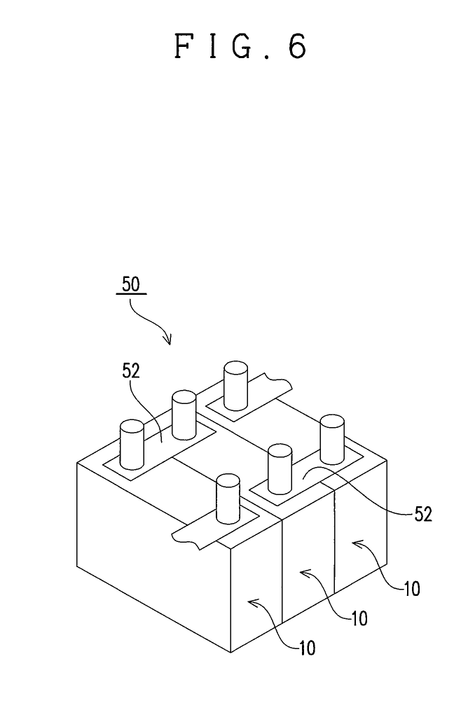

Further, the electric storage device (battery cell) 10 of the aforementioned embodiment may be used for an electric storage device module 50 shown in FIG. 6. The electric storage device module 50 has at least two electric storage devices 10 and bus bar members 52 that electrically connect the two (different) electric storage devices 10 to each other. In this case, it suffices that the technique of the present invention is applied to at least one of the electric storage devices 10.

### Example 1

In order to confirm the advantageous effects of the battery cell according to the present invention, how the properties in relation to charge and discharge (capacity retention rate in this example) change in a charge-discharge cycle test was investigated herein, using battery cells (first to sixth battery cells) each including a case and a winding core with a different ratio P₂/P₁ of the first pressure P₁ and the second pressure P₂.

The first battery cell used herein was as follows.

A case body was made of aluminum alloy (A1085). The width of the case body (dimension in the X-axis direction in FIG. 1) was 120 mm, the depth thereof (dimension in the Y-axis direction in FIG. 1) was 12.5 mm, the height thereof (dimension in the Z-axis direction in FIG. 1) was 85 mm, and the thickness of each of the circumferential walls and the bottom wall thereof was 0.6 mm.

Aluminum alloy (A1085) was a member with an aluminum purity of 99% or more. Specific components of aluminum alloy (A1085) were: 0.10% or less of Si, 0.12% or less of Fe, 0.03% or less of Cu, 0.02% or less of Mn, 0.02% or less of Mg, 0.03% or less of Zn, 0.03% or less of Ga, 0.05% or less of V, 0.02% or less of Ti, and 99.85% or more of Al.

A cover plate was made of aluminum alloy (A1085), and the thickness of the cover plate was 0.6 mm.

A winding core was a hollow winding core in an oblong shape (with both ends in a semicircular shape) formed by winding a polyphenylene sulfide plate with a thickness of 1 mm and a width of 95 mm. The height of the winding core (dimension in the Z-axis direction in FIG. 5) was 65 mm, and the thickness thereof (depth: dimension in the Y-axis direction in FIG. 5) was 3 mm. Further, the thickness of the hollow portion of the winding core was 1 mm.

An electrode assembly was formed by winding a positive electrode and a negative electrode around the circumference of the winding core, with a polyethylene separator interposed therebetween to have the positive electrode and the negative electrode being isolated from each other. As a positive electrode active material of the positive electrode, LiNi_{1/3}Co_{1/3}Mn_{1/3}O₂ was used. As a negative electrode active material of the negative electrode, graphite was used. This electrode assembly was housed within the case body, and was electrically connected to terminal parts attached to the cover plate. Thus, the first battery cell was formed. The initial capacity of the first battery cell was 6 Ah.

A first pressure P₁ applied to the case used for the first battery cell, and a second pressure P₂ applied to the winding core used for the first battery cell were each measured by analysis, using computer simulation, of a model into which the aforementioned material, shape, and dimensions were input. At this time, the first pressure P₁ applied to the case was analyzed in the state (condition) where a long wall facing a long wall to be pressed by a circular indenter was bound. Further, the second pressure P₂ applied to the winding core was analyzed in the state (condition) where a flat part facing a flat part to be pressed by the circular indenter was bound.

Specifically, the first pressure P₁ and the second pressure P₂ were measured as follows.

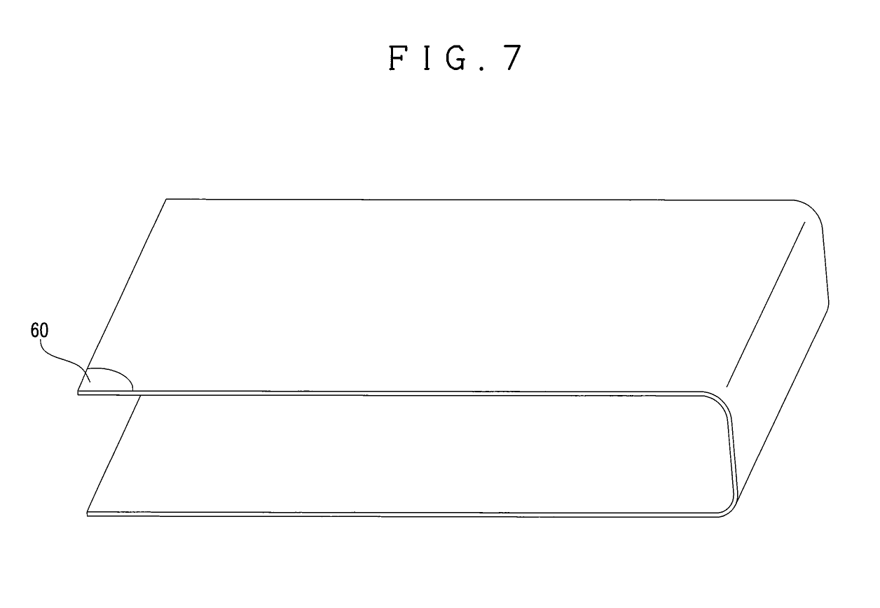

The case used for the first battery cell of this example had a substantially rectangular parallelepiped shape with all of the circumferential walls, the bottom wall, and the cover plate having the same thickness. Therefore, the first pressure P₁ was analyzed using a symmetry constrained one-fourth model as shown in FIG. 7. Since the case was such a symmetry constrained one-fourth model, a one-fourth model was used also as the circular indenter. The center of the case in this model pressed by the circular indenter was located inside a fan-shaped portion 60 with an internal angle of 90°, which is surrounded by a solid line in FIG. 7.

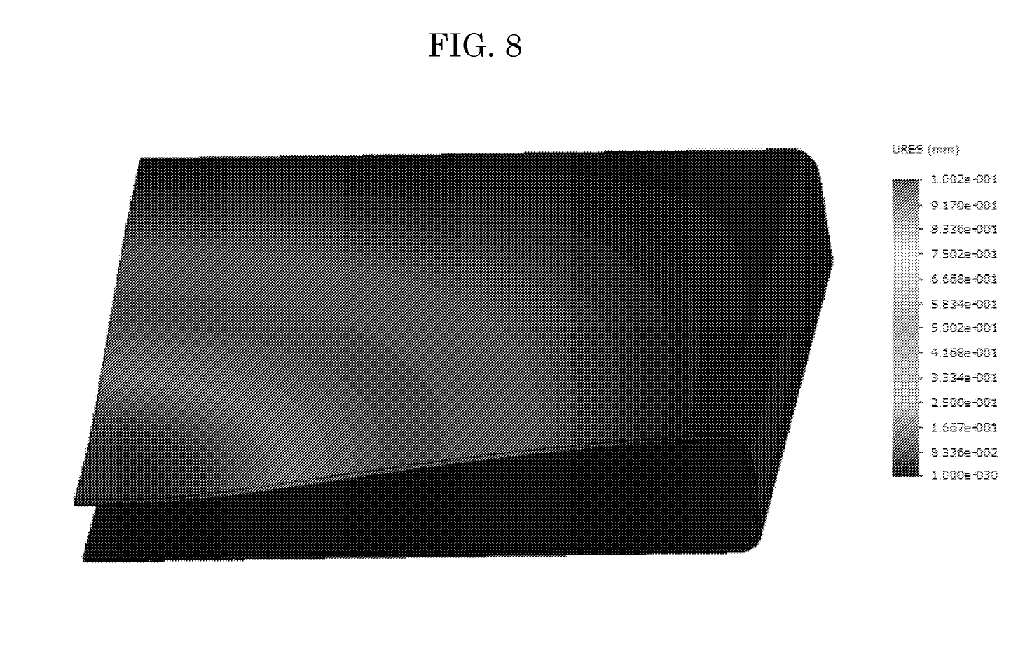

FIG. 8 shows an analysis view showing the state where the center of this model was displaced 1 mm from the initial position by being pressed by the circular indenter. As seen from FIG. 8, each part of the case was displaced from the initial position with the fan-shaped portion 60 at the center. With such a state, the pressure applied to the center by the circular indenter was analyzed. Thus, the first pressure P₁ was measured.

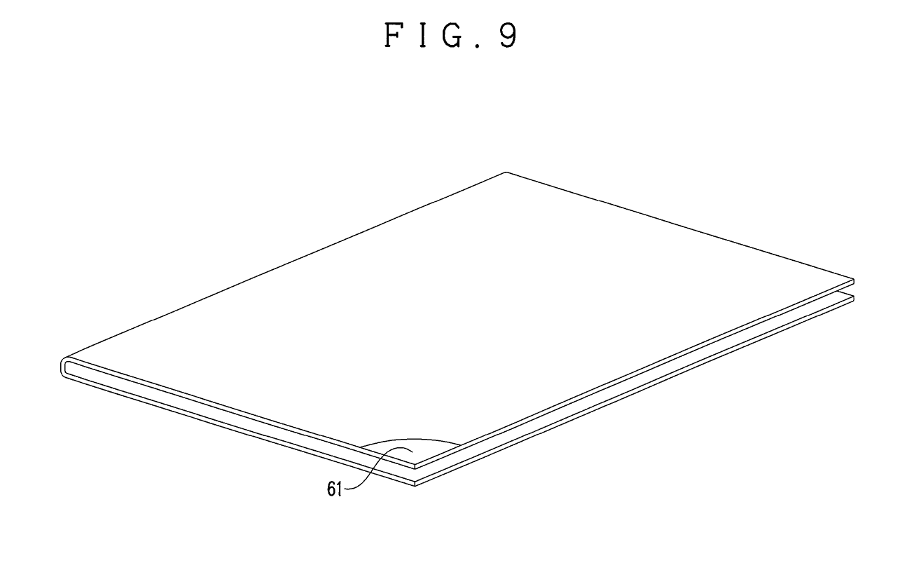

The winding core used for the first battery cell of this example had an oblong shape (flat cylindrical shape) formed by winding a polyphenylene sulfide plate having a uniform thickness. Therefore, the second pressure P₂ was analyzed using a symmetry constrained one-fourth model as shown in FIG. 9. Since the winding core was such a symmetry constrained one-fourth model, a one-fourth model was used also as the circular indenter. The center of the winding core in this model pressed by the circular indenter was located inside a fan-shaped portion 61 with an internal angle of 90°, which is surrounded by a solid line in FIG. 9.

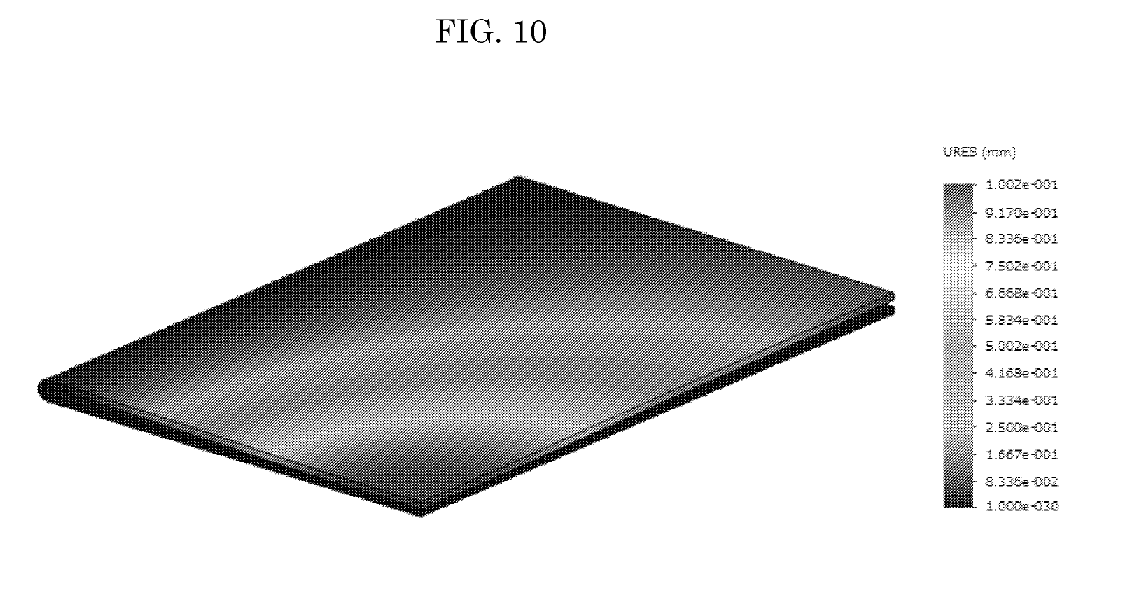

FIG. 10 shows an analysis view showing the state where the center of this model was displaced 1 mm from the initial position by being pressed by the circular indenter. As seen from FIG. 10, each part of the winding core was displaced from the initial position with the fan-shaped portion 61 at the center. With such a state, the pressure applied to the center by the circular indenter was analyzed. Thus, the second pressure P₂ was measured.

The first pressure P₁ of the case used for the first battery cell as measured was 4.5 kgf/cm². The second pressure P₂ of the winding core used for the first battery cell as measured was 4.8 kgf/cm². Accordingly, the ratio P₂/P₁ of the first pressure P₁ and the second pressure P₂ in the first battery cell was 0.94 (≈1).

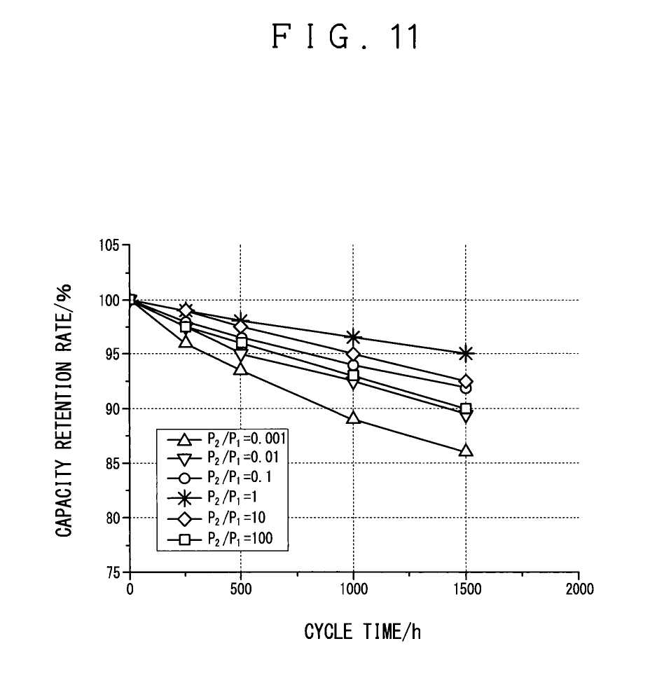

The first battery cell configured as above was subjected to a continuous charge-discharge test, under an environment at an atmospheric (ambient) temperature of 5° C., with an SOC (State Of Charge) of 0 to 100% (2.75 to 4.2 V) at 1 C rate (current value at which the total capacity of the battery cell was charged and discharged over one hour). In this charge-discharge cycle test, only after a lapse of 250, 500, 1000, 1500 hours, charge and discharge were paused, and the capacity was measured. FIG. 11 shows the results as P₂/P₁=1.

Further, battery cells (second to sixth battery cells) with a ratio P₂/P₁ of the first pressure P₁ and the second pressure P₂ being respectively 0.001, 0.01, 0.1, 10, and 100 were prepared by adjusting the thickness of each of the case (the case body and the cover plate) and the winding core. Each battery cell was subjected to a continuous charge-discharge test, under a 5° C. environment, with an SOC of 0 to 100% (2.75 to 4.2 V) at 1 C rate, in the same manner as above. FIG. 11 shows the results.

From these results, it could be confirmed that, when the ratio P₂/P₁ of the first pressure P₁ and the second pressure P₂ satisfies 0.01≦P₂/P₁≦100, the deterioration rate in properties in relation to charge and discharge was reduced to about 10% at 1500 cycle times/h. Further, from these results, it could be also confirmed that, when the ratio P₂/P₁ of the first pressure P₁ and the second pressure P₂ is 1 (P₂/P₁=1), the deterioration of properties in relation to charge and discharge could be most suppressed.

The electric storage device and the electric storage device module of this embodiment are as described above. However, the present invention is not limited to the aforementioned embodiments, and the design can be appropriately modified within the scope intended by the present invention. The operational advantage of the present invention is also not limited to the foregoing embodiments.

That is, the embodiments disclosed herein should be construed in all respects as illustrative but not limiting. The scope of the present invention is not indicated by the foregoing description but by the scope of the claims. Further, the scope of the present invention is intended to include all the modifications equivalent in the sense and the scope to the scope of the claims.

What is claimed is:

1. An electric storage device comprising:
an electrode assembly including a winding core and electrodes wound around a circumference of the winding core; and
a case including a circumferential wall, the case housing the electrode assembly therein in a state where the electrodes are closely stacked between the circumferential wall and the winding core, wherein
the case and the winding core each have a rigidity satisfying 0.01≦P₂/P₃≦100, where P₂/P₁ is a ratio of a first pressure P₁ applied to a first part as a specific part of the case by an indenter when the first part is pressed by the indenter so as to be displaced 1 mm from the initial position in a state where the electrode assembly is not housed in the case, and a second pressure P₂ applied to a second part as a part of the winding core facing the first part by the indenter when the second part is pressed by the indenter so as to be displaced 1 mm from the initial position in a state where the electrodes are not wound.

2. The electric storage device according to claim 1, wherein
the first pressure P₁ and the second pressure P₂ are each at least 1 kgf/cm².

3. The electric storage device according to claim 1, wherein
the first pressure P₁ and the second pressure P₂ are each not more than 100 kgf/cm².

4. The electric storage device according to claim 1, wherein
the ratio P₂/P₁ of the first pressure P₁ and the second pressure P₂ satisfies 0.1≦P₂/P₁≦10.

5. The electric storage device according to claim 1, wherein
the ratio P₂/P₁ of the first pressure P₁ and the second pressure P₂ is 1.

6. The electric storage device according to claim 1, wherein
the case comprises:
a rectangular bottom wall;
a pair of long walls erected from positions along long sides of circumferential edges of the bottom wall; and
a pair of short walls erected from positions along short sides of circumferential edges of the bottom wall, the pair of short walls connecting ends of the pair of long walls that face each other.

7. The electric storage device according to claim 6, wherein
the winding core comprises flat parts,
the case houses the electrode assembly to have the flat parts of the winding core and the long walls being substantially in parallel, and
the electrodes are sandwiched between the long walls of the case and the flat parts of the winding core.

8. An electric storage device module comprising:
the electric storage device according to claim 1; and
a bus bar member electrically connected to the electric storage device.
